(19) United States
(12) Patent Application Publication
(10) Pub. No.: US 2008/0017127 A1
(43) Pub. Date: Jan. 24, 2008

(54) Rabbit cage stand and organizer device

(76) Inventor: Lisa M. Nettleship, Whitehouse, NJ (US)

Correspondence Address: Kenneth P. Glynn, 24 Mine Street, Flemington, NJ, 08822, US

(21) Appl. No.: 11/490,735

(22) Filed: Jul. 21, 2006

(51) Int. Cl. A01K 31/07

(52) U.S. Cl. 119/453

(57) ABSTRACT

The present invention is a pet cage stand and organizer device, which comprises a main cabinet structure having a front, back, sides, top and bottom as well as at least one door. The main cabinet structure has at least one divider wall on its inside to create a first storage area for hay, bedding, litter and other non-food products and a second storage area, isolated from the first storage area, for storage of food and other sanitary pet accessories. It also includes a cage support frame that has sidewall means located on the main cabinet structure top or side, to inhibit movement of a cage.

### BACKGROUND OF INVENTION

a. Field of Invention

The invention relates generally to rabbits and other pets that are typically small four legged caged animals. More particularly the present invention relates to a portable device that has multifaceted capabilities including cage support, sleep and litter storage, separate food and accessory storage and an instant playpen. In addition, the present invention provides compactness as well as mobility.

b. Description of Related Art

The following patents are representative of pet tables and storage systems:

U.S. Pat. No. 6,732,676 B1 describes an integrated pet storage crate and grooming table. The integrated table includes a structure having a pet storage area covered by an openable gate, an equipment storage area for storing equipment, a horizontal surface resting on a top portion of the pet storage area and the equipment storage area, and a grooming surface rotatably connected to the horizontal surface. The grooming surface, which may be optionally covered with a material, covers the equipment storage area in a vertical orientation and is rotated upwardly to a horizontal orientation against the horizontal surface to provide an area for grooming a pet. The structure also includes a plurality of wheels mounted on a bottom surface of the structure allowing mobility of the structure. In addition, a telescopic ramp is mounted under the bottom surface of the structure to facilitate movement of the structure.

U.S. Pat. No. 5,755,180 describes a carrying case for pet accessories. The carrying case includes a container having at least one compartment accommodating a variety of pet accessories. The container includes a closure for selectively opening and closing the container to permit access to the at least one compartment. The carrying case also includes a picture frame mounted on the outer surface of the container and an identifying picture of a pet housed within the picture frame.

U.S. Pat. No. 5,349,924 describes an animal kennel which comprises a removable partition which is inserted into a housing through a partition slot in a rear housing sidewall. The removable partition is guided by partition tracks extending between the rear housing sidewall partition slot to be positioned between two door openings in a front housing sidewall. A removable drop-in tray can be inserted into a partition lock slot by opening a top door for locking the removable partition in position. The kennel also includes shallow fixed trays having tray sidewalls which are parallel to, but slightly spaced from housing sidewalls, with air, or inlet, ports being in the housing sidewalls adjacent the tray sidewalls. The front doors include vent ports which are defined by outwardly-protruding, funnel-shaped wall portions. Foam is mounted on an interior surface of the top door for impinging on items in the fixed trays when the top door is closed.

U.S. Pat. No. 4,735,173 describes an animal transport unit which comprises a housing having a bottom, a top, a pair of side walls and a pair of end walls, the top being movable between an open position whereat the housing is fully uncovered to provide a top opening and a closed position whereat the top forms a closure covering the top opening, and a floor inside the housing and overlying the bottom, the floor being movably mounted for movement between an upper limit position adjacent the top and a lower limit position adjacent the bottom. The unit further includes an opening formed in at least one of the walls and openable closure means covering the wall opening, the closure means being openable to allow an animal to enter or exit the housing through the wall opening and to be supported on the floor when in the housing, and means for raising and lowering the floor to move same between the upper and lower limit positions whereby, when the top is in the open position, the floor can be raised to elevate the animal through the top opening of the housing for access to the animal. There are also provided ventilation means permitting air to enter and exit from the interior of the housing as well as roller means for enabling the housing to be moved with the animal therein to transport same. The animal transport unit according to the invention is particularly useful for transporting show animals at showgrounds where the top of the unit can be opened and the floor raised so as to form in the elevated position a grooming tabletop for grooming the animal and on which the animal once groomed may stand for inspection.

Notwithstanding the prior art, the present invention is neither taught nor rendered obvious thereby.

### SUMMARY OF INVENTION

The invention solves the problems and overcomes the drawbacks and deficiencies of prior art cages, grooming tables, supply cabinets, playpens, etc. by providing a complete single device addressing all of the foregoing in a universal fashion, not only does the present invention device provide all of the mentioned functions in a single unit, but it does so in a physically compact and economically advantageous fashion.

The present invention, in its first embodiment, is a pet cage stand and organizer device that includes a main cabinet structure having a front, back, sides, top and bottom as well as at least one door. The main cabinet structure has at least one divider wall on its inside to create a first storage area for hay, bedding, litter and other non-food products and a second storage area, isolated from the first storage area, for storage of food and other sanitary pet accessories. It also includes a cage support frame that has sidewall means located on the main cabinet structure top, to inhibit movement of a cage. It has a plurality of wheels located on the bottom and at least one pet pen system connected to the main cabinet structure. The system has a first, stored position and a second, open position. The first, stored position, occupies a small fraction of the footprint area of the device, and the second, open position, system creates a continuous loop from the main cabinet structure away from it and back to the main cabinet structure to create an open pen for a pet.

The present invention, in its first embodiment, pet cage stand and organizer device main cabinet structure may include at least two doors. At least one of the doors is located on the front of the main cabinet structure. The second storage area including at least one shelf.

In its first embodiment, the present invention pet cage stand and organizer device pet pen system may include at least three hinged wall sections rotatably connected to one another. The first end may be connected to the main cabinet structure adjacent a front corner and has a second end that may be connected to said main cabinet structure at a rear corner.

The present invention, in its first embodiment, pet cage stand and organizer device may further include a pet cage located within the cage support frame. The pet cage stand and organizer device may have a main cabinet structure that is formed of molded plastic and wheels that are caster wheels. The pet cage stand and organizer device has cage support frame, and may include a removable base tray for positioning under a pet cage.

The present invention, in its second embodiment, pet cage stand and organizer device that includes a main cabinet structure having a front, back, sides, top and bottom and having at least one door. The main cabinet structure has at least one divider wall on its inside to create a first storage area for hay, bedding, litter and other non-food products and a second storage area isolated from said first storage area for storage of food and other sanitary pet accessories. It also includes a cage support frame that has sidewall means to inhibit movement of a cage when the cage is positioned thereon. The present invention, in its second embodiment, has a plurality of wheels located on the bottom and at least one pet pen system connected to the main cabinet structure, the system having a first, stored position and a second, open position wherein, when in the first, stored position, it occupies a small fraction of the footprint area of the device, and when in the second, open position, the system creates a continuous loop from the main cabinet structure away from it and back to the main cabinet structure to create an open pen for a pet.

The present invention, in its second embodiment, pet cage stand and organizer device main cabinet structure may include at least two doors. At least one door is located on the front of the main cabinet structure. The second storage area includes at least one shelf.

The present invention, in its second embodiment, pet cage stand and organizer device pet pen system may include at least three hinged wall sections rotatably connected to one another. The first end connected to main cabinet structure adjacent a first front corner and has a second end connected to said main cabinet structure at a second front corner.

The present invention, in its second embodiment, pet cage stand and organizer device may further include a pet cage located within the cage support frame. The main cabinet structure is formed of molded plastic and the wheels are caster wheels. The pet cage stand and organizer device may have cage support frame, that may include a removable base tray for positioning under a pet cage.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 shows an oblique front view of one embodiment of the present invention pet cage stand and organizer device;

FIG. 2 is the present invention device shown in FIG. 1, but with the pet playpen in its open position;

FIG. 3 shows a top view of the present invention pet cage stand and organizer device with the cage, tray and top of the cabinet removed;

FIG. 4 shows a front view of an alternative embodiment present invention pet cage stand and organizer with the pet playpen in its closed position;

FIG. 5 is the present invention device shown in FIG. 4, but with the pet playpen in its open position;

FIG. 6 shows a top view of the present invention pet cage stand and organizer device with the cage, tray and top of the cabinet removed;

FIG. 7 shows a top view on the present invention pet cage stand and organizer device shown in FIG. 5 and with the cage, tray and top of the cabinet removed and with the pet playpen in an open position at the front of the main cabinet structure so that the rabbit or other pet may exercise in the playpen and freely enter and exit its cage for access to its litter, feed and bedding at any time; and,

FIGS. 8a, 8b, 8c, 8d, 8e and 8f show cut top views and top views of the use of an unfolding pet pen system to create a side playpen and, alternatively, to create a front playpen.

### DETAILED DESCRIPTION OF THE EMBODIMENTS

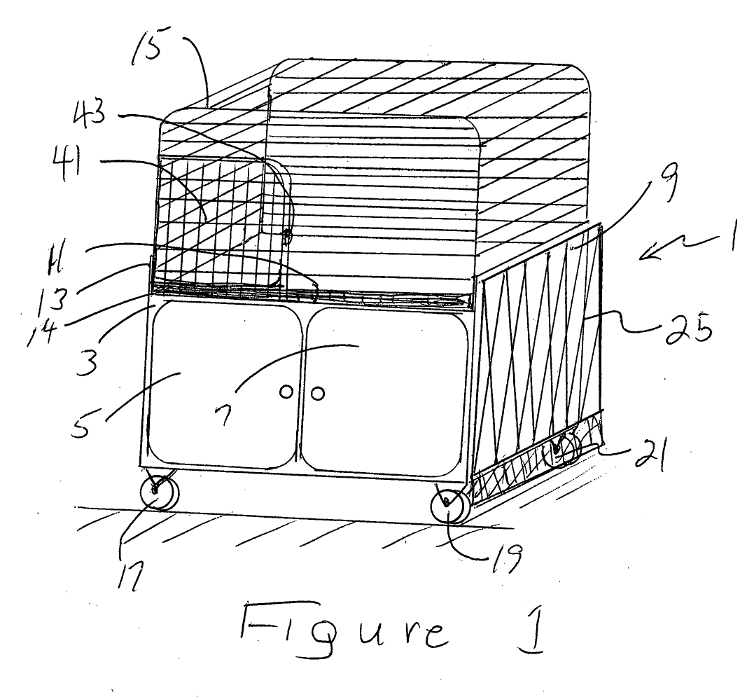

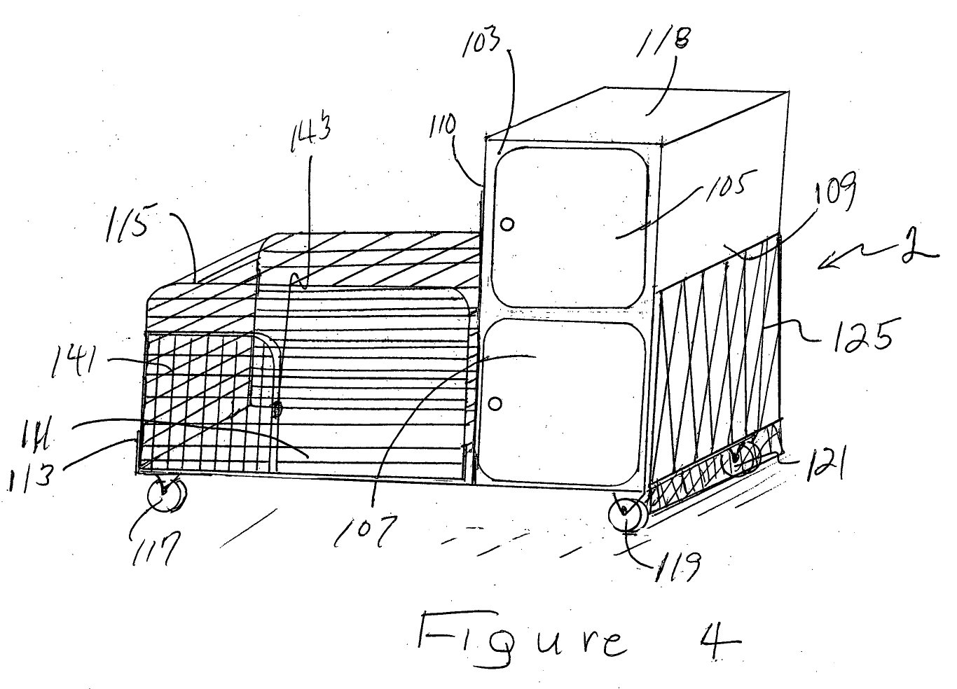

Referring now to the drawings wherein like reference numerals designate corresponding parts throughout the several views, the present invention details are with respect to a first embodiment shown in FIGS. 1 through 3 and a second embodiment shown in FIGS. 4 through 7.

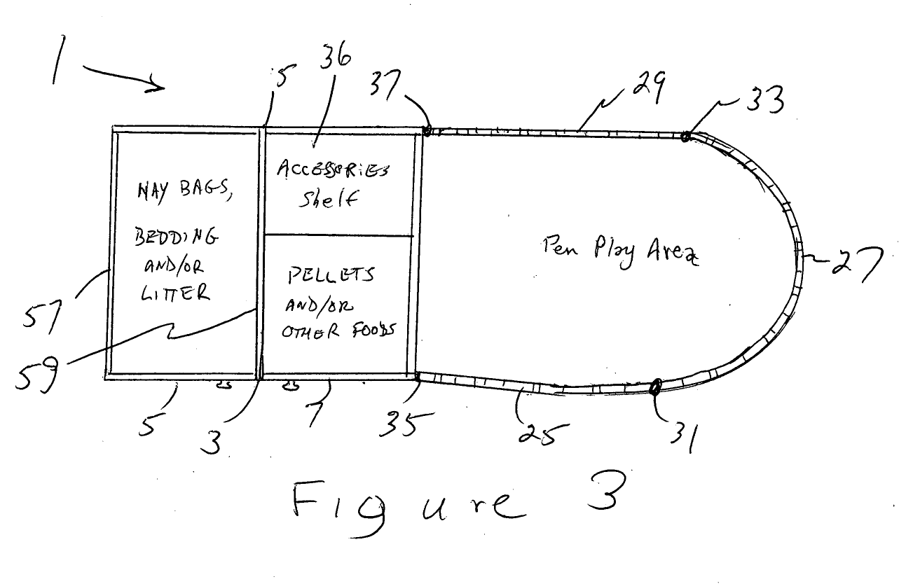

FIG. 1 shows a front oblique view of present invention “over/under” pet cage stand and organizer device 1. Device 1 includes a main cabinet structure having a front 3, a back 5 (FIG. 3) and sides such as right side 9 and a top 11, as well as a bottom (not shown). Wheels are located on the bottom for mobility, and these could be disk wheels, ball wheels, etc, and lockable caster wheels are preferred in some embodiments. Thus, wheels 17, 19 and 21 are shown.

Device 1 also includes front cabinet doors 5 and 7. Any number of doors could be used, and could be located on any surface that is accessible, but it is important that the main cabinet structure include at least one solid divider wall. The top of device 1 has a cage support frame 13 that, in this embodiment, is an upward extension of the sidewalls and back of the main cabinet structure. Alternatively, this cage support frame could be rails, tabs, resting ridges or any other similar means that would reduce or eliminate sliding movement of a cage positioned thereon.

Cage 15 has a door 41 with a latch 43 and may be any domestic pet cage that will fit on the main cabinet structure top. Optional base tray 14 may also be included to prevent droppings and other materials from contacting the main cabinet structure for cages that do not have solid bottoms or inside trays.

There is a permanently or removably attached instant pet exercise and playpen system that includes a wall or plurality of wall sections such as wall section 25. As shown in FIG. 1, the pet pen system is in a folded or closed position.

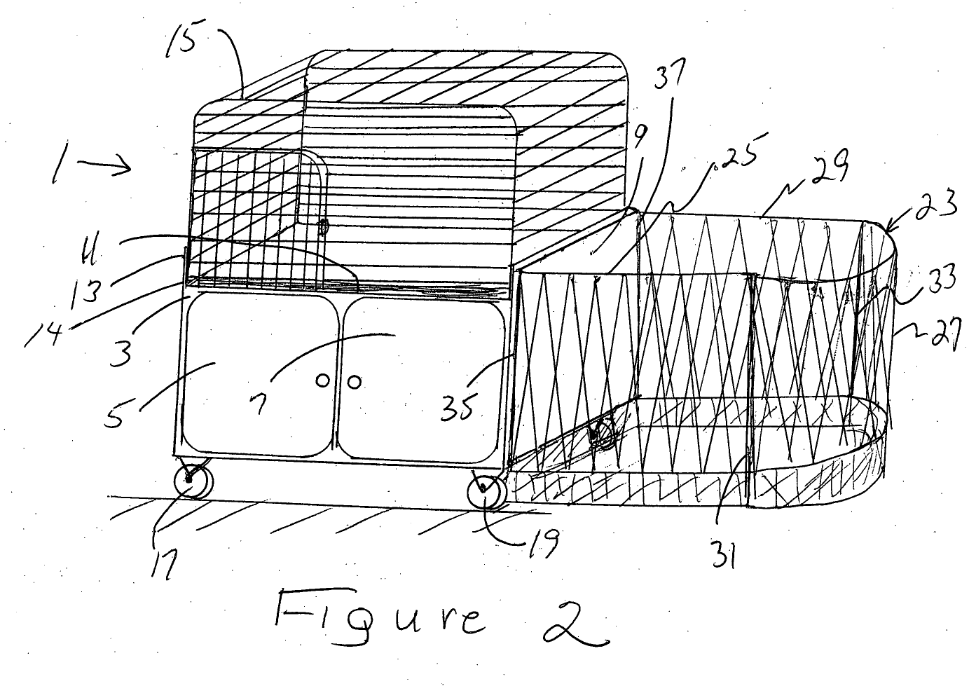

FIG. 2 shows a view of present invention pet cage stand and organizer device 1 of FIG. 1 but with the pet pen system open for placement of a pet therein. Thus, wall section 25 may be swung open to the front, wall section 27 open to the side and wall section 29 open to the back as shown, to create a side playpen. Hinges 31, 33 and 35 allow for such movement to enable quick opening and closing. Attachment member 37 allows removable attachment, such as a clip or drop bolt, to create the exercise and play area shown.

FIG. 3 shows a top view of pet cage stand and organizer device 1 from FIG. 2 and illustrates this view with the cage and top removed. Divider wall 59 separates the left door 5 section from the right door 7 section so that bedding, hay, litter, etc. can be sanitarily separated from food, etc. One or more shelves, such as shelf 36, may be used on one or both sides of divider wall 59.

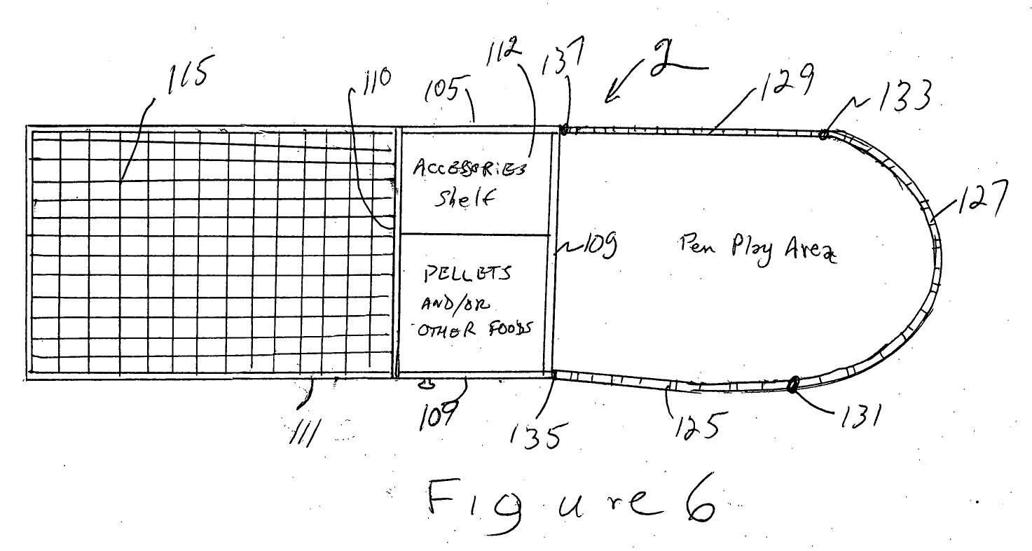

FIG. 4 shows a front oblique view of present invention “side-by-side” pet cage stand and organizer device 2. Device 2 includes a main cabinet structure having a front 103, a back 105 (FIG. 6), right side 109, left side 110, and a top 118, as well as a bottom (not shown). Wheels 117, 119 and 121 are located on the bottom for mobility.

Device 2 also includes front cabinet doors 105 and 107. Top door 105 could alternatively be on top 118, as a hatch. The left side of device 2 has a cage support frame 113 that, in this embodiment, is a side extension of the sidewall of the main cabinet structure. Alternatively, this cage support frame could be a base with rails, tabs, resting ridges or any other similar means that would reduce or eliminate sliding movement of a cage positioned thereon.

Cage 115 has a door 141 and may be any domestic pet cage that will fit on the main cabinet structure cage support frame.

There is a permanently or removably attached instant pet exercise and playpen system that includes a wall or plurality of wall sections such as wall section 125. As shown in FIG. 4, the pet pen system is in a closed position.

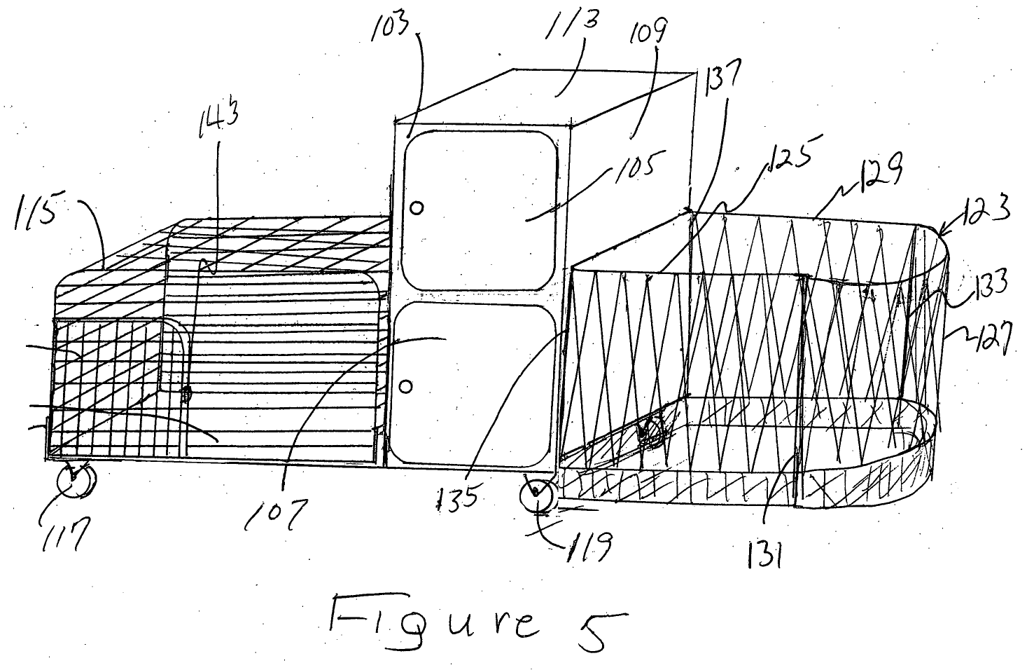

FIG. 5 shows a view of present invention pet cage stand and organizer device 2 of FIG. 4 but with the pet pen system open for placement of a pet therein. Thus, wall section 125 may be swung open to the front, wall section 127 open to the side and wall section 129 open to the back as shown, to create a side playpen. Hinges 131, 133 and 135 allow for such movement to enable quick opening and closing. Attachment member 137 allows removable attachment, such as a clip or drop bolt, to create the exercise and play area shown.

FIG. 6 shows a top view of pet cage stand and organizer device 2 from FIG. 5 and illustrates this view with the cabinet top removed. A divider wall (not shown) separates the top door 105 section from the bottom door 107 section so that bedding, hay, litter, etc. can be sanitarily separated from food, etc. One or more shelves, such as shelf 112, may be used on one or both areas of the cabinet.

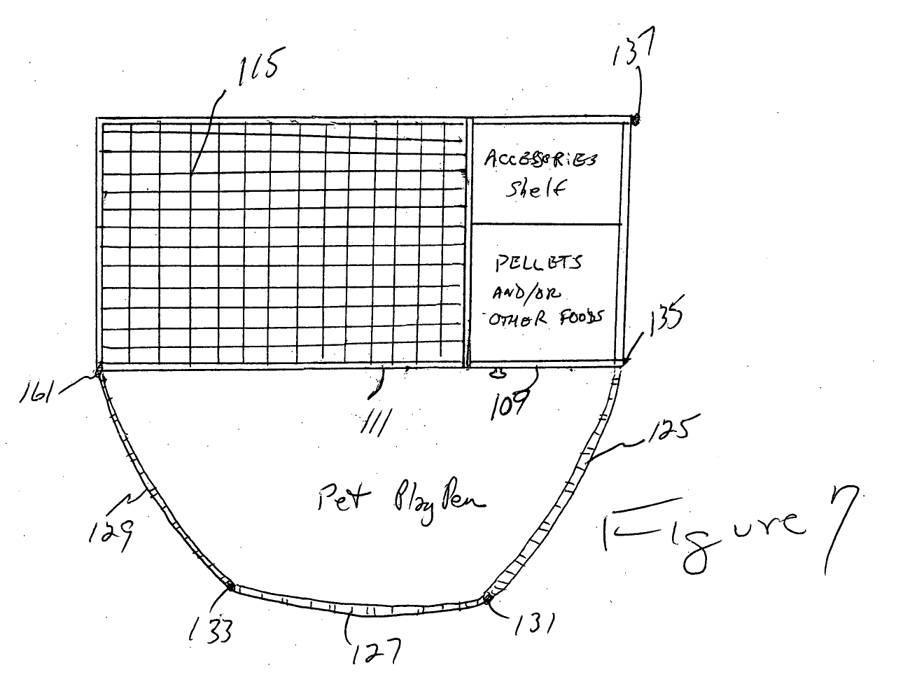

FIG. 7 shows a top view of pet cage stand and organizer device 2 from FIG. 5 with a top of the cabinet removed and with the pet playpen system in an open position but swung around and attached to the front. With the cage door open, a pet may exercise and play in the pen and revisit his cage for food, sleep and other needs.

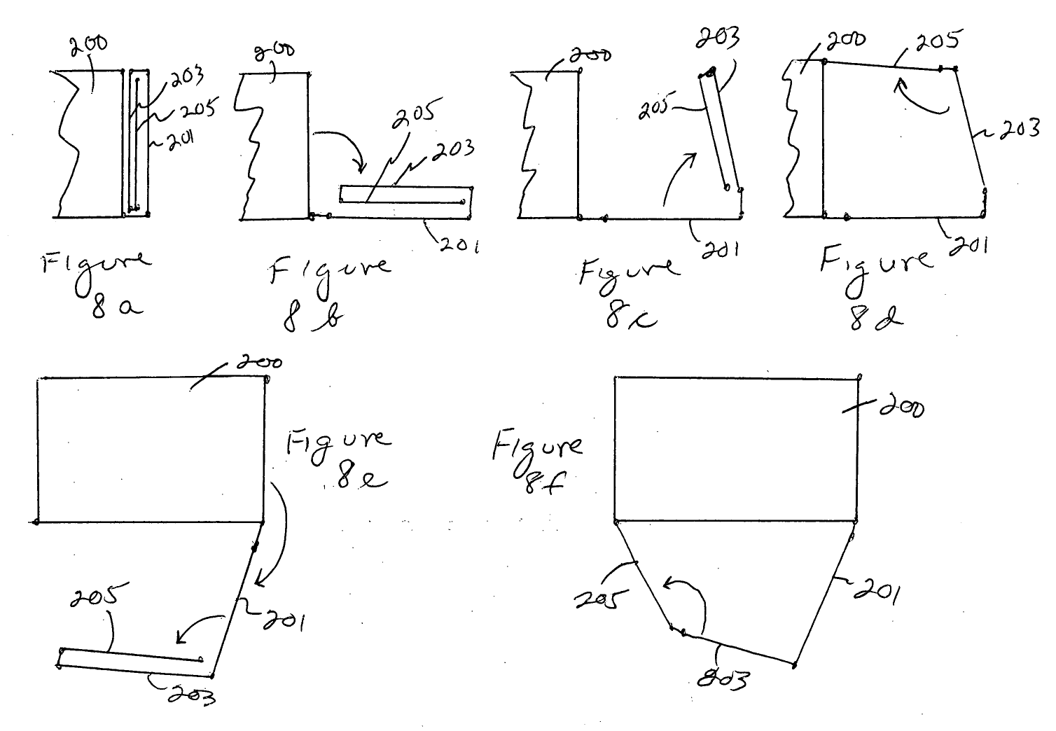

FIGS. 8a through 8f show partial top views of a present invention device 200 using a stick figure pet playpen system with walls 201, 203 and 205, as well as hinge points and attachment points as shown. In FIGS. 8a, 8b, 8c and 8d, these walls are opened to create a side playpen. In FIGS. 8a, 8e and 8f, a front playpen is created.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A pet cage stand and organizer device, which comprises:
a.) a main cabinet structure having a front, back, sides, top and bottom and having at least one door, said main cabinet structure having at least one divider wall on its inside to create a first storage area for hay, bedding, litter and other non-food products and a second storage area isolated from said first storage area for storage of food and other sanitary pet accessories;
b.) a cage support frame having sidewall means and located on said main cabinet structure top, to inhibit movement of a cage when said cage is positioned thereon;
c.) a plurality of wheels located on said bottom;
d.) at least one pet pen system connected to said main cabinet structure, said system having a first, stored position and a second, open position wherein, when in said first, stored position, it occupies a small fraction of the footprint area of said device, and when in said second, open position, said system creates a continuous loop from said main cabinet structure away from it and back to said main cabinet structure to create an open pen for a pet.

2. The pet cage stand and organizer device of claim 1 wherein said main cabinet structure includes at least two doors.

3. The pet cage stand and organizer device of claim 1 wherein said at least one door is located on said front of said main cabinet structure.

4. The pet cage stand and organizer device of claim 1 wherein said second storage area includes at least one shelf.

5. The pet cage stand and organizer device of claim 1 wherein said pet pen system includes at least three hinged wall sections rotatably connected to one another.

6. The pet cage stand and organizer device of claim 5 wherein said pet pen system has a first end connected to said main cabinet structure adjacent a front corner and has a second end connected to said main cabinet structure at a rear corner.

7. The pet cage stand and organizer device of claim 1 which further comprises a pet cage located within said cage support frame.

8. The pet cage stand and organizer device of claim 1 wherein said main cabinet structure is formed of molded plastic.

9. The pet cage stand and organizer device of claim 1 wherein said wheels are caster wheels.

10. The pet cage stand and organizer device of claim 1 wherein said cage support frame includes a removable base tray for positioning under a pet cage.

11. A pet cage stand and organizer device, which comprises:
a.) a main cabinet structure having a front, back, sides, top and bottom and having at least one door, said main cabinet structure having at least one divider wall on its inside to create a first storage area for hay, bedding, litter and other non-food products and a second storage area isolated from said first storage area for storage of food and other sanitary pet accessories;
b.) a cage support frame having sidewall means to inhibit movement of a cage when said cage is positioned thereon said cage support frame being located on a side said main cabinet structure;
c.) a plurality of wheels located on said bottom;
d.) at least one pet pen system connected to said main cabinet structure, said system having a first, stored position and a second, open position wherein, when in said first, stored position, it occupies a small fraction of the footprint area of said device, and when in said second, open position, said system creates a continuous loop from said main cabinet structure away from it and back to said main cabinet structure to create an open pen for a pet.

12. The pet cage stand and organizer device of claim 11 wherein said main cabinet structure includes at least two doors.

13. The pet cage stand and organizer device of claim 11 wherein said at least one door is located on said front of said main cabinet structure.

14. The pet cage stand and organizer device of claim 11 wherein said second storage area includes at least one shelf.

15. The pet cage stand and organizer device of claim 11 wherein said pet pen system includes at least three hinged wall sections rotatably connected to one another.

16. The pet cage stand and organizer device of claim 15 wherein said pet pen system has a first end connected to said main cabinet structure adjacent a first front corner and has a second end connected to said main cabinet structure at a second front corner.

17. The pet cage stand and organizer device of claim 11 which further comprises a pet cage located within said cage support frame.

18. The pet cage stand and organizer device of claim 11 wherein said main cabinet structure is formed of molded plastic.

19. The pet cage stand and organizer device of claim 11 wherein said wheels are caster wheels.

20. The pet cage stand and organizer device of claim 11 wherein said cage support frame includes a removable base tray for positioning under a pet cage.
